(19) United States
(12) Patent Application Publication
(10) Pub. No.: US 2008/0051181 A1
(43) Pub. Date: Feb. 28, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/648,562

(22) Filed: Jan. 3, 2007

Related U.S. Application Data
(60) Provisional application No. 60/840,017, filed on Aug. 25, 2006.

(51) Int. Cl. A63F 13/00

(52) U.S. Cl. 463/20

(57) ABSTRACT

In a display window in which a scatter symbol was repositioned in a preceding game, a corresponding reel is set in hold state to keep repositioning of symbols including the scatter symbol unchanged without spinning even when a next game begins. On the other hand, in other display window in which a scatter symbol was not repositioned in the preceding game, a corresponding reel spins and stops when the next game begins. When each reel in which a scatter symbol was not repositioned in the preceding game stops spinning, repositioning of symbols in each display window in a next game is determined.

### CROSS-REFERENCE TO THE RELATED APPLICATION (S)

This application is based upon and claims a priority from the U.S. provisional Patent Application No. 60/840,017 filed on Aug. 25, 2006, the entire contents thereof are incorporated herein by reference.

### BACKGROUND OF THE INVENTION

1. Field of the Invention

The present invention relates to a slot machine and playing method thereof in which a payout is awarded depending on a symbol combination consisting of repositioned symbols.

2. Description of Related Art

In conventional slot machines, a combination of symbols amongst plural symbols repositioned in a matrix is defined by symbols positioned on a pay line, and in case a symbol combination on the pay line coincides with a winning symbol combination, a payout associated with the winning symbol combination is awarded.

In this regard, a pay line generally passes through all of the columns in a matrix.

U.S. Pat. No. 6,604,999B2 and US Patent Application Publication No. 2002/0065124A1 disclose a gaming machine in which a special pay line which passes through fewer than all of the columns in a matrix is provided so as to enhance player's interest to games.

### SUMMARY OF THE INVENTION

The object of the present invention is to provide a slot machine and playing method thereof which has new entertaining factors which conventional ones did not have inherently.

Therefore, in order to achieve the object, according to a first aspect of the present invention, there is provided a slot machine comprising: a display for displaying plural symbols positioned; at least one scatter symbol to which a payout is awarded depending on number of scatter symbols displayed in the display; and a game controller programmed to operate with the display (a) to cause the display to newly reposition and display plural symbols every game, and (b) set all of the at least one scatter symbol displayed in a preceding game in hold state by excluding all of the at least one scatter symbol from repositioning when the display newly repositions and displays plural symbols in a next game.

Furthermore, according to a second aspect of the present invention, there is provided a slot machine comprising: a display for displaying plural symbols positioned; at least one scatter symbol to which a payout is awarded depending on number of scatter symbols displayed in the display; and a game controller programmed to operate with the display (a) to cause the display to newly reposition and display plural symbols every game, and (b) in case at least one scatter symbol has been displayed in a preceding game, (1) to award a payout depending on number of scatter symbols displayed in the preceding game firstly and then, to determine whether or not to set all of the at least one scatter symbol in hold state by excluding all of the at least one scatter symbol from repositioning when the display newly repositions and displays plural symbols in a next game, (2) to determine number of continual games to keep setting all of the at least one scatter symbol displayed in the preceding game in hold state by excluding all of the at least one scatter symbol from repositioning when the display newly repositions and displays plural symbols on condition that a determination at (1) is to set all of the at least one scatter symbol in hold state in the next game, and (3) to cause the display to newly reposition and display plural symbols in accordance with determinations at (1) and (2).

Furthermore, according to a third aspect of the present invention, there is provided a slot machine comprising: a display for displaying plural symbols positioned; at least one scatter symbol to which a payout is awarded depending on number of scatter symbols displayed in the display; and a game controller programmed to operate with the display (a) to cause the display to newly reposition and display plural symbols every game, and (b) in case at least one scatter symbol has been displayed in a preceding game, (1) to award a payout depending on number of scatter symbols displayed in the preceding game firstly and then, to determine whether or not to set all of the at least one scatter symbol in hold state by excluding all of the at least one scatter symbol from repositioning when the display newly repositions and displays plural symbols in a next game, (2) to cause the display to newly reposition and display plural symbols on condition that a determination at (1) is to set all of the at least one scatter symbol in hold state in the next game, and (3) in case the display newly displays a scatter symbol in the next game, to award a payout depending on number of total scatter symbols including the scatter symbol newly displayed.

Furthermore, according to a fourth aspect of the present invention, there is provided a slot machine comprising: a display for displaying plural symbols positioned; at least one scatter symbol to which a payout is awarded depending on number of scatter symbols displayed in the display; and a game controller programmed to operate with the display (a) to cause the display to newly reposition and display plural symbols every game, and (b) in case at least one scatter symbol has been displayed in a preceding game, (1) to award a payout depending on number of scatter symbols displayed in the preceding game firstly and then, to determine whether or not to set all of the at least one scatter symbol in hold state by excluding all of the at least one scatter symbol from repositioning when the display newly repositions and displays plural symbols in a next game, (2) to cause the display to newly reposition and display plural symbols on condition that a determination at (1) is to set all of the at least one scatter symbol in hold state in the next game, and (3) in case the display newly displays a scatter symbol in the next game, to award a payout depending on number of total scatter symbols including the scatter symbol newly displayed.

Furthermore, according to a fifth aspect of the present invention, there is provided a method of playing a slot machine in which game controller repeats a game by using a display which newly repositions and displays plural symbols and at least one scatter symbol to which a payout is awarded depending on number of scatter symbols displayed in the display, the playing method comprising steps of (a) causing the display to newly reposition and display plural symbols every game with the game controller; and (b) setting all of the at least one scatter symbol displayed in a preceding game in hold state by excluding all of the at least one scatter symbol from repositioning with the game controller when the display newly repositions and displays plural symbols in a next game.

Furthermore, according to a sixth aspect of the present invention, there is provided a method of playing a slot machine in which game controller repeats a game by using a display which newly repositions and displays plural symbols and at least one scatter symbol to which a payout is awarded depending on number of scatter symbols displayed in the display, the playing method comprising steps of: (a) causing the display to newly reposition and display plural symbols every game with the game controller; (b) in case at least one scatter symbol has been displayed in a preceding game, awarding a payout depending on number of scatter symbols displayed in the preceding game firstly and then, determining whether or not to set all of the at least one scatter symbol in hold state by excluding all of the at least one scatter symbol from repositioning with the game controller when the display newly repositions and displays plural symbols in a next game; (c) determining number of continual games to keep setting all of the at least one scatter symbol displayed in the preceding game in hold state by excluding all of the at least one scatter symbol from repositioning with the game controller when the display newly repositions and displays plural symbols on condition that a determination at the step (b) is to set all of the at least one scatter symbol in hold state in the next game; and (d) causing the display to newly reposition and display plural symbols in accordance with determinations at the steps (1) and (2) with the game controller.

Furthermore, according to a seventh aspect of the present invention, there is provided a method of playing a slot machine in which game controller repeats a game by using a display which newly repositions and displays plural symbols and at least one scatter symbol to which a payout is awarded depending on number of scatter symbols displayed in the display, the playing method comprising steps of: (a) causing the display to newly reposition and display plural symbols every game with the game controller; (b) in case at least one scatter symbol has been displayed in a preceding game, awarding a payout depending on number of scatter symbols displayed in the preceding game firstly and then, determining whether or not to set all of the at least one scatter symbol in hold state by excluding all of the at least one scatter symbol from repositioning with the game controller when the display newly repositions and displays plural symbols in a next game; (c) causing the display to newly reposition and display plural symbols with the game controller on condition that a determination at the step (b) is to set all of the at least one scatter symbol in hold state in the next game; and (d) in case the display newly displays a scatter symbol in the next game at the step (c), awarding a payout depending on number of total scatter symbols including the scatter symbol newly displayed with the game controller.

Furthermore, according to an eighth aspect of the present invention, there is provided a method of playing a slot machine in which game controller repeats a game by using a display which newly repositions and displays plural symbols and at least one scatter symbol to which a payout is awarded depending on number of scatter symbols displayed in the display, the playing method comprising steps of: (a) causing the display to newly reposition and display plural symbols every game with the game controller; (b) in case at least one scatter symbol has been displayed in a preceding game, awarding a payout depending on number of scatter symbols displayed in the preceding game firstly and then, determining whether or not to set all of the at least one scatter symbol in hold state by excluding all of the at least one scatter symbol from repositioning with the game controller when the display newly repositions and displays plural symbols in a next game; (c) determining number of continual games to keep setting all of the at least one scatter symbol displayed in the preceding game in hold state by excluding all of the at least one scatter symbol from repositioning with the game controller when the display newly repositions and displays plural symbols on condition that a determination at the step (b) is to set all of the at least one scatter symbol in hold state in the next game; (d) causing the display to newly reposition and display plural symbols in accordance with determinations at the steps (b) and (c) with the game controller; and (e) in case the display newly displays a scatter symbol in the next game, awarding a payout depending on number of total scatter symbols including the scatter symbol newly displayed with the game controller.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a diagram for illustrating a feature of typical game developments that may be encountered in accordance with the principles of the present invention;

FIG. 2 is a perspective view showing an outline construction of the slot machine;

FIG. 3 is an exemplary diagram of symbol columns depicted on reel bands of respective reels of the slot machine;

FIG. 4 is an exemplary block diagram showing a control system of the slot machine;

FIG. 5 is a first payout table showing winning symbol combinations and payouts associated with the respective winging symbol combinations applied during a base game;

FIG. 6 is a second payout table showing winning symbol combinations and payouts associated with the respective winging symbol combinations applied during a base game;

FIG. 7 is a diagram depicting what is displayed in a lower-side image display panel;

FIG. 8 is a diagram depicting what is displayed in the lower-side image display panel;

FIG. 9 is a flowchart of a main control program;

FIG. 10 is a flowchart of a main game processing program;

FIG. 11 is a flowchart of a symbol display control processing program;

FIG. 12 is a flowchart of a hold state determination processing program;

FIG. 13 is a perspective view showing an outline construction of a slot machine directed to other embodiment; and

FIG. 14 is an exemplary block diagram showing a control system of the slot machine.

### DETAILED DESCRIPTION OF THE PREFERRED EMBODIMENTS

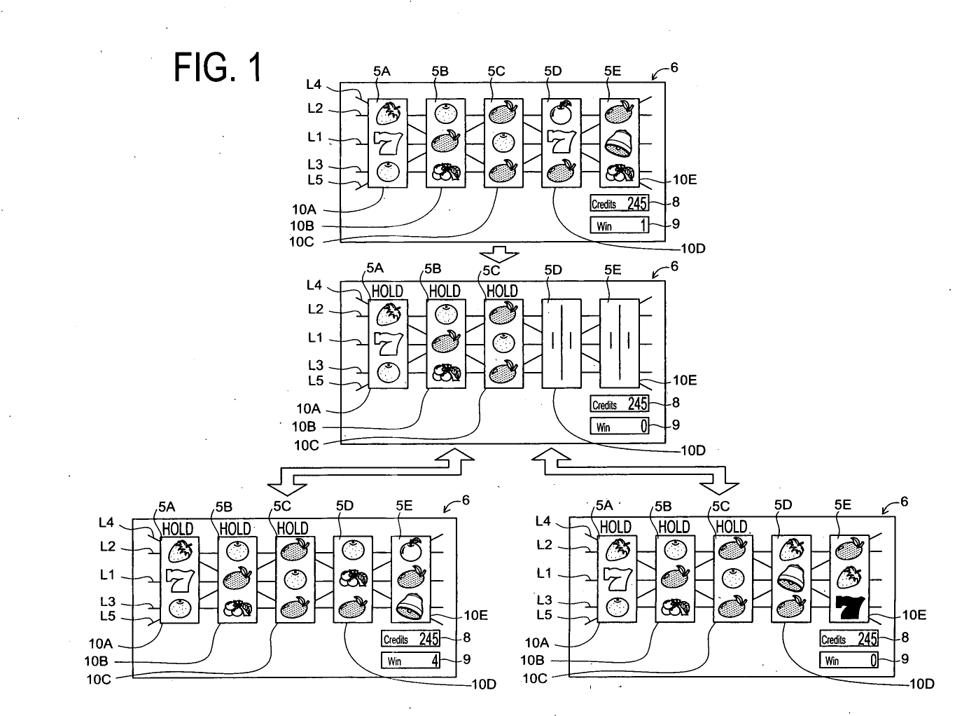

FIG. 1 is a diagram for illustrating a feature of typical game developments that may be encountered in accordance with the principles of the present invention. In the slot machine directed to the present embodiment, as shown in FIG. 1, a lower-side image display panel 6 is a video display and displays five display windows 10A, 10B, 10C, 10D, and 10E all of which are visible. Through each of the display windows 10A, 10B, 10C, 10D, and 10E, three symbols depicted on respective reel bands of the reels 5A, 5B, 5C, 5D, and 5E, are positioned in a form of three rows in a column. Accordingly, in the lower-side image display panel 6, fifteen symbols in total are positioned in a form of 3 rows×5 columns matrix. Furthermore, in the lower-side image display panel 6, there are formed five pay lines L1, L2, L3, L4, and L5 each of which passes through the five display windows 10A, 10B, 10C, 10D, and 10E. Furthermore, a credit amount display section 8 and a payout amount display section 9 are provided at the lower part of the lower-side image display panel 6. There have previously been determined various winning symbol combinations.

In every base game carried out by the slot machine of the present embodiment, some or all of the five pay lines L1, L2, L3, L4, and L5 is/are activated depending on the number of bets. After that, the reels 5A, 5B, 5C, 5D, and 5E virtually spin and stop, whereby three symbols, three rows in a column, are repositioned in each of the display windows 10A, 10B, 10C, 10D, and 10E. In case a combination of five symbols repositioned on an activated pay line L coincides with a certain winning symbol combination, a payout for the winning symbol combination is awarded to a player. Furthermore, in case plural winning symbol combinations are concurrently repositioned on plural activated pay lines L, payouts for the respective winning symbol combinations are totalized and awarded to a player.

In case plural “ORANGE” symbols, defined as scatter symbol in the embodiment, are repositioned in some of the display windows 10A, 10B, 10C, 10D, and 10E, a payout for a combination of “ORANGE” symbols and any symbol(s) (termed as “scatter-and-any combination payout” hereinafter) is awarded to a player depending on the number of “ORANGE” symbols on condition that three, four, or five “ORANGE” symbols are repositioned in succession from the left-most display window 10A or from the right-most display window 10E regardless whether or not the scatter symbols are repositioned on one of the pay line L1, L2, L3, L4, and L5.

Furthermore, in a display window 10 in which an “ORANGE” symbol was repositioned in a preceding game, a corresponding reel 5 is set in hold state to keep repositioning of preceding three symbols (three rows in a column) including an “ORANGE” symbol unchanged without spinning even when a next game begins. On the other hand, in other display window 10 in which an “ORANGE” symbol was not repositioned in the preceding game, a corresponding reel 5 spins and stops when the next game begins. In case an “ORANGE” symbol is newly repositioned in a display window 10 of which reel 5 is not set in hold state in the next game, a payout depending on the number of total “ORANGE” symbols including the hold-state “ORANGE” symbol is awarded to a player.

To be more specific, as shown at an upper stage of FIG. 1, in case an “ORANGE” symbol is displayed in each of the display windows 10A, 10B, and 10C in a preceding game, it is regarded that three “ORANGE” symbols are displayed in succession from the left-most display window 10A and a payout for the three “ORANGE” symbols is awarded to a player.

As shown at a middle stage of FIG. 1, in the display windows 10A, 10B, and 10C in each of which an “ORANGE” symbol was repositioned in the preceding game, the corresponding reels 5A, 5B, and 5C are set in hold state to keep repositioning of preceding three symbols (three rows in a column) unchanged without spinning even when the next game begins. On the other hand, as shown at the middle stage of FIG. 1, in the display windows 10D and 10E in both of which an “ORANGE” symbol was not repositioned in the preceding game, the corresponding reels 5D and 5E spin when the next game begins. As shown at a lower stage of FIG. 1, the reels 5D and 5E stop spinning, whereby three symbols are newly repositioned in each of the display windows 10A, 10B, 10C, 10D, and 10E in the next game.

In case an “ORANGE” symbol is newly repositioned in the display window 10D as shown at a left side of the lower stage in FIG. 1, it is regarded that “ORANGE” symbols are repositioned in succession from the left-most display window 10A through the display window 10D and a payout for four “ORANGE” symbols is awarded to a player. In case an “ORANGE” symbol is not newly repositioned in the display window 10D as shown at a right side of the lower stage in FIG. 1, a payout is not awarded to a player.

In case an “ORANGE” symbol is repositioned in a display window 10 in a preceding game, determination on whether or not to set the display window 10 in hold state in a next game is made after a payout depending on the number of “ORANGE” symbols is awarded to a player.

In case it is determined to set the display window 10 in hold state in the next game, the number of continual games to keep hold state is determined concurrently.

The embodiment of the present invention will be described in detail by referring to the drawings.

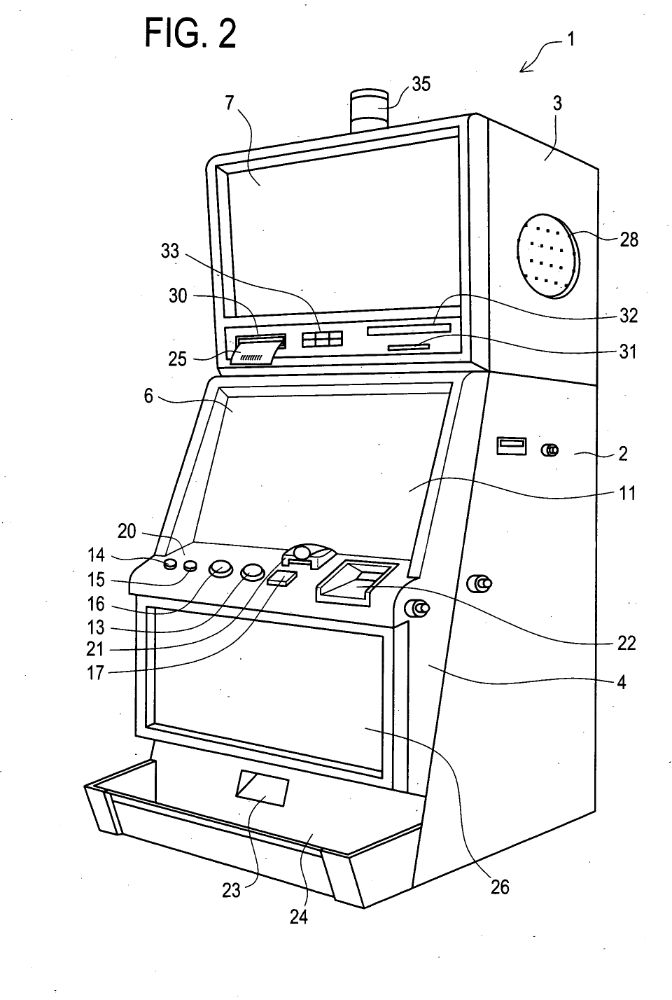

Firstly, schematic structure of a slot machine 1 directed to the embodiment will be described by referring to FIG. 2. FIG. 2 is a perspective view showing an outline construction of the slot machine 1.

The slot machine 1 directed to the present embodiment includes: a cabinet 2; a top box 3 arranged above of the cabinet 2; and a main door 4 provided on a front face of the cabinet 2.

An upper-side image display panel 7 is provided on a front face of the top box 3. The upper-side image display panel 7 is structured with a well-known crystal liquid panel which usually displays demonstration animation, information about the slot machine such as game rules, payout table, and the like.

A lower-side image display panel 6 is provided on the main door 4.

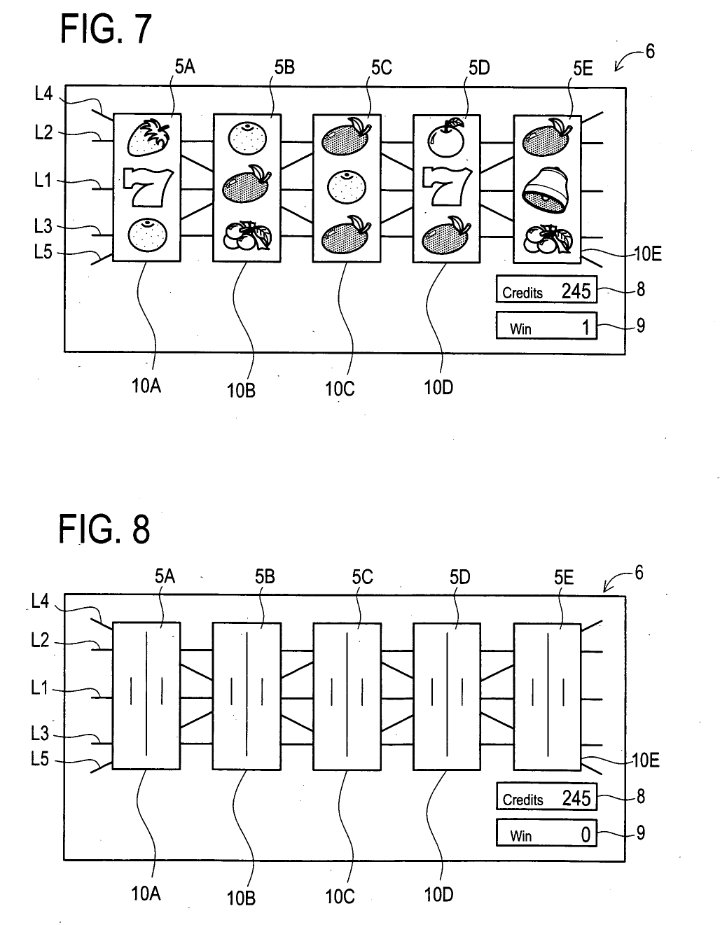

Here will be described game-related images to be displayed in the lower-side image display panel 6 of the slot machine 1. As examples of game-related images, FIG. 7 and FIG. 8 depict what are displayed in the lower-side image display panel 6. During a base game, as shown in FIG. 7 and FIG. 8, there are visibly displayed symbols depicted on reel bands of the reels 5A, 5B, 5C, 5D, and 5E through the display windows 10A, 10B, 10C, 10D, and 10E, respectively, in the lower-side image display panel 6. FIG. 7 shows a state that symbols depicted on respective reel bands of the reels 5A, 5B, 5C, 5D, and 5E are positioned or repositioned. FIG. 8 shows a state that reels 5A, 5B, 5C, 5D, and 5E are virtually spinning.

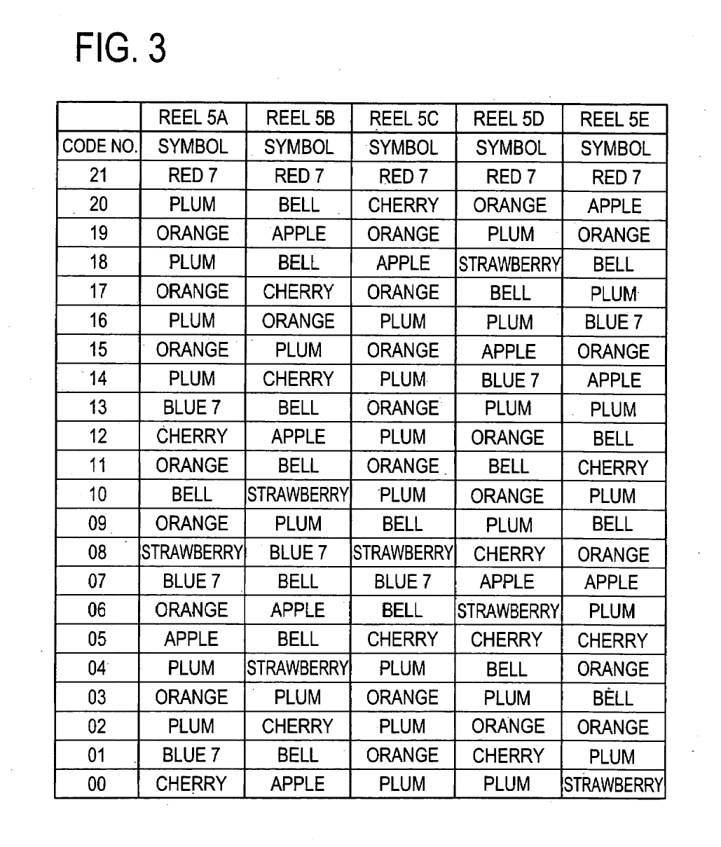

It is to be noted that a symbol column consisting of twenty-two symbols is depicted on reel bands of respective reels 5A, 5B, 5C, 5D, and 5E (see FIG. 3).

Furthermore, a touch panel 11 (see FIG. 2) is provided on a front face of the lower-side image display panel 6, whereby a player can input various instructions with the touch panel 11.

Furthermore, a credit amount display section 8 and a payout amount display section 9 are provided in the lower-side image display panel 6. The credit amount display section 8 displays amount of credits the player currently holds. The payout amount display section 9 displays: amount of payout to be awarded in case a symbol combination repositioned on an activated pay line L coincides with a certain winning symbol combination; amount of payout to be awarded in case a scatter-and-any combination payout is won; and amount of payouts won by a bonus game.

That is, the five display windows 10A, 10B, 10C, 10D, and 10E are made visible and displayed in the lower-side image display panel 6, and in the display windows 10A, 10B, 10C, 10D, and 10E, three symbols, three rows in a column, depicted on reel bands of respective reels 5A, 5B, 5C, 5D, and 5E are positioned.

As shown in FIG. 7 and FIG. 8, there are formed five pay lines L1, L2, L3, L4, and L5 each of which passes through the five display windows 10A, 10B, 10C, 10D, and 10E in the lower-side image display panel 6. Each of the pay lines L1, L2, L3, L4, and L5 is to define a combination of five symbols thereon.

It is to be noted that, during a bonus game, predetermined bonus game images are displayed together with the credit amount display section 8 and the payout amount display section 9 in a state that images of the display windows 10A, 10B, 10C, 10D, and 10E (including the reels 5A, 5B, 5C, 5D, and 5E) and the pay lines L1, L2, L3, L4, and L5 are erased out.

Back to FIG. 2, below the lower-side image display panel 6, there are provided a control panel 20 which consists of plural buttons with which a player inputs instructions concerning game progress, a coin insertion slot 21 for accepting coins, gaming media, in the cabinet 2, and a bill validator 22.

The control panel 20 includes a spin button 13, a change button 14, a CASHOUT button 15, a I-BET button 16 and a MAX-BET button 17. The spin button 13 is operation means for inputting an instruction to let the reels 5A, 5B, 5C, 5D, and 5E start spinning. The change button 14 is operation means for asking a shop keeper of money changing. The CASHOUT button 15 is operation means for inputting an instruction to pay out coins equivalent to the amount of credits a player has earned (1 coin for 1 credit) to a coin tray 24 through a coin payout opening 23 or for inputting an instruction to pay out credits in a form of bar-code ticket 25 to be described later.

The 1-BET button 16 is operation means for accepting an instruction to wager 1 credit upon a game out of all the credits a player has held. The MAX-BET button 17 is operation means for accepting an instruction to wager maximum number of credits (5 credits is the maximum number in the present embodiment) a player can wager upon per one game out of all the credits the player has held.

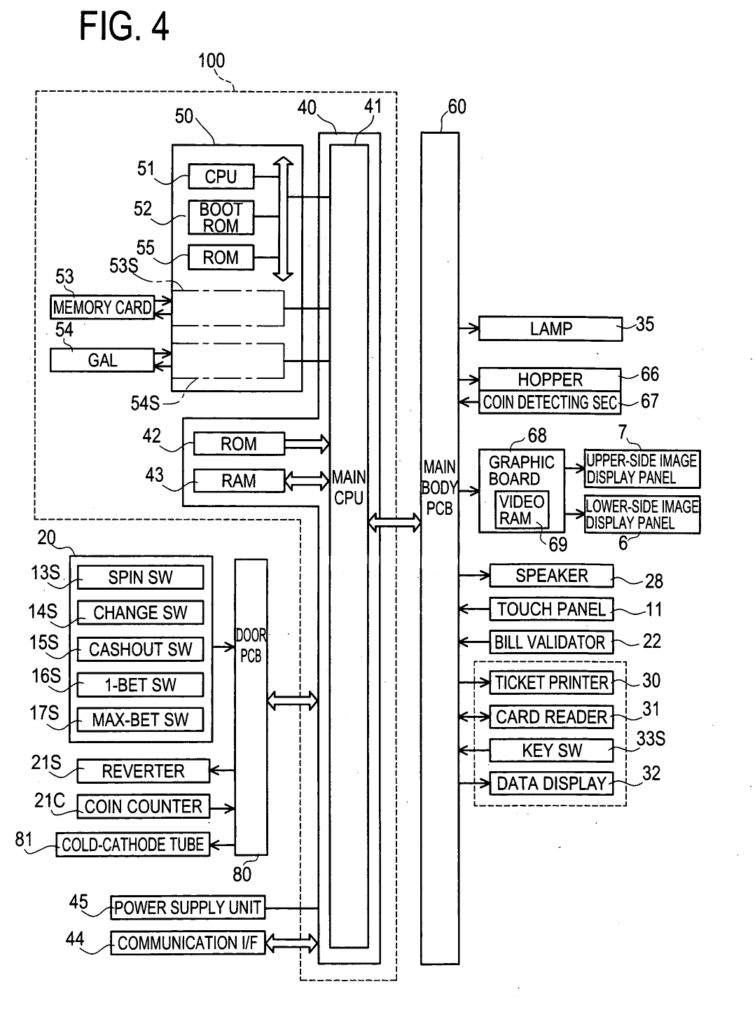

Inside of the coin insertion slot 21, a reverter 21S and a coin counter 21C (see FIG. 4 for both) are provided. The reverter 21S discriminates forgery of coins and expels improper coins from the coin payout opening 23. The coin counter 21C detects proper coins accepted by the coin counter 21C and counts the number of them.

The bill validator 22 discriminates counterfeit bills and accepts authentic bills into the cabinet 2. Bills inserted in the cabinet 2 are converted into the number of coins and credits equivalent to the converted number of coins are added to credits the player should hold. Incidentally, the bill validator 22 is able to read a bar-code ticket 25 to be described later. On a lower front face of the main door 4, i.e., a lower portion of the control panel 20, there is provided a glass panel 26 on which character(s) of the slot machine 1 or the like is depicted.

As to the slot machine 1 directed to the present embodiment, coins, bills, or electric valuable information (credit) corresponding to coins and bills are used as gaming media. However, in the present invention, types of gaming media are not restricted to the above. For example, medal, token, electric money, ticket, and the like are applicable as gaming media.

Below the upper-side image display panel 7, a ticket printer 30, a card reader 31, a data display 32 and a key pad 33 are provided.

The ticket printer 30 is a printing device for printing a bar-code on a ticket in which data of the amount of credits, a date, an identification number of the slot machine 1, and the like are encoded, and outputting such a ticket as bar-code ticket 25. A player gets other gaming machine read the outputted bar-code ticket 25 so as to play a game with the target gaming machine or to take certain procedures at a certain section in a game arcade (e.g., a cashier in a casino).

The card reader 31 is to read data from a smart card and, vice versa, to write data in a smart card. A smart card is a card a player should bring with him/her and, for example, data concerning game history of the player, and the like are recorded thereon.

The data display 32 is made of fluorescent display or the like and displays data read by the card reader 31 and data inputted by a player with the key pad 33, for example. The key pad 33 is used for inputting instructions and data concerning issuance of ticket and the like. Furthermore, a lamp 35 is provided on a top face of the top box 3. The lamp 35 is turned on and flashes in a predetermined manner so as to summon a shop keeper when an error occurs to the slot machine 1.

Incidentally, “28” is a speaker.

Next, by referring to FIG. 3, there will be described symbols depicted on reel bands of respective reels 5A, 5B, 5C, 5D, and 5E, which are scrolled and repositioned in the display windows 10A, 10B, 10C, 10D, and 10E in the lower-side image display panel 6 during a game. FIG. 3 shows exemplary symbol columns depicted on reel bands of respective reels 5A, 5B, 5C, 5D, and 5E.

Twenty-two symbols are depicted on reel bands of respective reels 5A, 5B, 5C, 5D, and 5E. Each symbol column is made by combining “RED7”, “BLUE7”, “BELL”, “CHERRY”, “STRAWBERRY”, “PLUM”, “ORANGE”, and “APPLE”. As shown in FIG. 3, the above mentioned symbols are positioned on reel bands of respective reels 5A, 5B, 5C, 5D, and 5E in individually different orders and combinations.

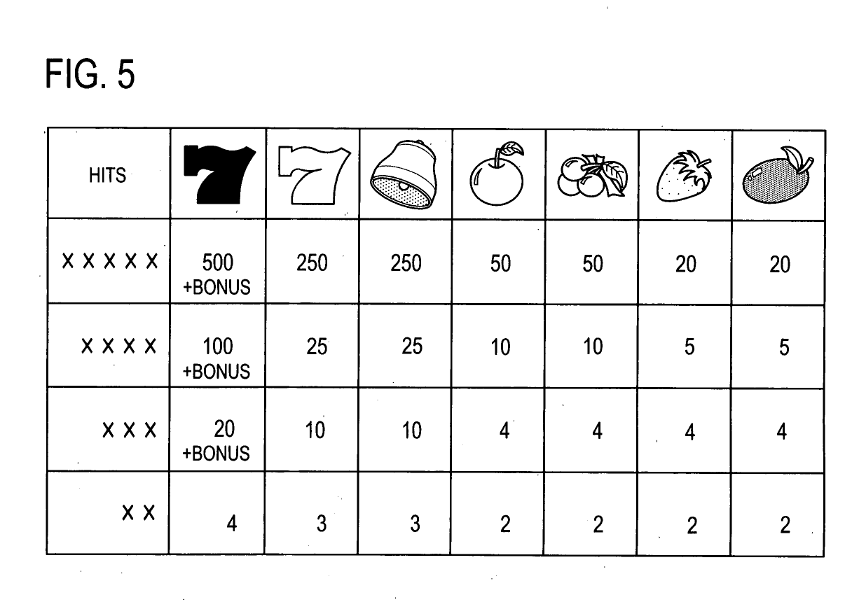

As to symbols “RED7”, “BLUE7”, “BELL”, “CHERRY”, “STRAWBERRY”, “PLUM”, and “APPLE”, when two, three, four, or five identical symbols out of the above are repositioned in succession from the left-most display window 10A or from the right-most display window 10E on an activated pay line L, predetermined amount of payout is awarded to a player (see FIG. 5).

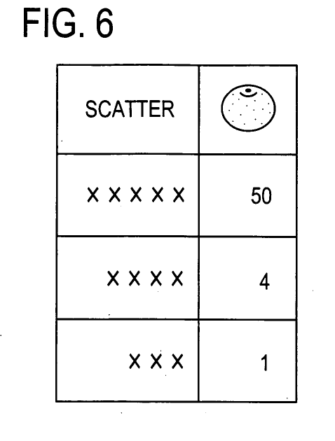

Furthermore, “ORANGE” is a scatter symbol of scatter-and-any combination payout. That is, predetermined amount of payout depending on the number of the scatter symbols is awarded to a player in case three, four, or five scatter symbols are displayed in succession from the left-most display window 10A or from the right-most display window 10E regardless whether or not the scatter symbols are repositioned on a certain pay line L (see FIG. 6).

In case three, four, or five “RED7” symbols are repositioned on an activated pay line L in succession from the left-most display window 10A or from the right-most display window 10E, predetermined amount of payout is awarded to a player and a bonus game occurs. Games to be carried out by the slot machine 1 directed to the present embodiment consist of two game modes, namely, base game and bonus game. A base game is played in such a manner that a player aims to reposition a certain symbol combination on activated the pay line(s) 1L, 2L, 3L, 4L, and 5L and the reels 5A, 5B, 5C, 5D, and 5E are used therein. In a base game, there is also carried out a game to win a scatter-and-any combination payout in which a player aims to reposition an “ORANGE” symbol, scatter symbol. On the other hand, a bonus game is played in such a manner that three jewelry boxes as choices are indicated in the lower-side image display panel 6, and then, a game directed to player's choice of a jewelry box associated with payout amount is carried out. Details of the bonus game will be omitted here.

A part of respective symbol columns depicted on reel bands of the reels 5A, 5B, 5C, 5D, and 5E, shown in FIG. 3, is displayed through corresponding display widows 10A, 10B, 10C, 10D, and 10E. That is, three symbols, three rows in a column, are repositioned and displayed through each of the display windows 10A, 10B, 10C, 10D, and 10E and fifteen symbols in total are repositioned. After the 1-BET button 16 or the MAX-BET button 17 is operated to designate the number of bets and the spin button 13 is pressed, symbol columns depicted on reel bands of respective reels 5A, 5B, 5C, 5D, and 5E in scroll from top to bottom are displayed through the corresponding display windows 10A, 10B, 10C, 10D, and 10E (see FIG. 8). After a predetermined time lapses, the reels 5A, 5B, 5C, 5D, and 5E stop spinning and a part of respective symbol columns of the reels 5A, 5B, 5C, 5D, and 5E is displayed through corresponding display windows 10L, 10C, and 10R. That is, three symbols, three rows in a column, are repositioned and displayed through each of the display windows 10A, 10B, 10C, 10D, and 10E, thereby fifteen symbols in total are repositioned (see FIG. 7). Furthermore, various winning symbol combinations (see FIG. 5) are previously determined. In case a symbol combination on one of activated pay lines L1, L2, L3, L4, and L5 coincides with a certain winning symbol combination, payout for the winning symbol combination is awarded to a player.

Furthermore, payouts associated with the number of “ORANGE” symbols are previously defined (see FIG. 6) and in case “ORANGE” symbols are repositioned in succession in the display windows 10A, 10B, 10C, 10D, and 10E, a payout depending on the number of “ORANGE” symbols is awarded to a player.

Next, there will be described a control system of the slot machine 1 directed to the present embodiment by referring to FIG. 4. FIG. 4 is a block diagram showing a control system of the slot machine 1 schematically.

As shown in FIG. 4, the control system of the slot machine 1 basically consists of a mother board 40 and a gaming board 50.

The gaming board 50 comprises: a CPU 51, a ROM 55, a boot ROM 52, connected to one another by internal bus; a card slot 53S for accepting a memory card 53; and an IC socket 54S compatible with GAL (Generic Array Logic) 54.

The memory card 53 is a non-volatile memory which is a recording medium to store a game program and a game system program (termed as game program and the like, hereafter) therein. The game program stored in the memory card 53 includes a lottery program. The lottery program is to choose a symbol from respective symbol columns of the reels 5A, 5B, 5C, 5D, and 5E and determine three symbols to be repositioned on the pay line L, (i.e., determine code numbers corresponding to respective symbols to be repositioned on the pay line L). The lottery program also includes symbol weight data associated with plural kinds of payout rate (e.g., 80%, 84%, 88%). The symbol weight data is data to associate code numbers of respective symbols (see FIG. 3) with one or plural random numbers belonging to a predetermined numerical value range (0˜255) with respect to each of the five reels 5A, 5B, 5C, 5D, and 5E. That is, one or plural random numbers is/are associated with a code number of a symbol. A random number is extracted through a lottery, whereby a symbol specified with the extracted random number(s) is repositioned.

Payout rate is determined in accordance with payout rate setting data outputted from the GAL 54 and a lottery is carried out in accordance with the symbol weight data associated with the payout rate.

Furthermore, the lottery program includes a program to determine whether or not to set a display window 10 in hold state in a next game in case an “ORANGE” symbol was repositioned in the display window 10 in a preceding game.

The lottery program also includes a program to determine the number of continual games to keep hold state in case the afore-mentioned program has determined to set the display window 10 hold state in a next game.

The card slot 53S is structured such that a memory card 53 can be inserted in and pulled out from there, and connected to the mother board 40 with IDE bus. Therefore, kinds of games and rules to be executed with the slot machine 1 can be changed by rewriting and changing contents of a game program and the like stored in the memory card 53 to other ones. Kinds of games and rules to be executed with the slot machine 1 can be also changed by replacing a memory card 53 which stores a game program and the like with other memory card 53 which stores other game program and the like.

Game program includes: a program concerning game progress; image data and sound data to be outputted during a game; image data of symbols depicted on reel bands of the respective reels 5A, 5B, 5C, 5D, and 5E; image data concerning game rules, payout table, and the like; and demonstration image data.

The GAL 54 is a kind of PLD which has OR-fixed type array structure. The GAL 54 has plural input ports and output ports and when certain data is inputted to an input port, data associated with the inputted data is outputted from an output port. The data outputted from the output port is the afore-mentioned payout setting data.

The IC socket 54S is structured such that the GAL 54 can be attached to and detached from there, and connected to the mother board 40 with PCI bus. Therefore, payout rate setting data to be outputted from the GAL 54 can be changed by writing over program to be stored in the detached GAL 54 or changing a GAL 54 with other GAL 54.

The CPU 51, the ROM 55 and the boot ROM 52 connected to one another with internal bus are connected to the mother board 40 with PCI bus. The PCI bus transmits signals between the mother board 40 and the gaming board 50 and supplies power from the mother board 40 to the gaming board 50. The ROM 55 stores country identification information and an authentication program. The boot ROM 52 stores an auxiliary authentication program, a program (boot code) with which the CPU 51 can activate the auxiliary authentication program, and the like.

The authentication program is a program (falsification-check program) for authenticating a game program and the like. The authentication program is described along falsification-check procedure of the game program and the like which is subject to an authentication-fetch processing. The auxiliary authentication program is a program for authenticating the afore-mentioned authentication program and is described along falsification-check procedure of the authentication program which is subject to an authentication processing.

Next, there will be described the mother board 40. The mother board 40 is constituted by a commercially available and versatile mother board (printed-wiring board on which essential parts of a personal computer are mounted), and equipped with a main CPU 41, a ROM 42, and a RAM 43.

The ROM 42 consists of a memory device such as flash memory or the like, and stores programs such as BIOS to be executed by the main CPU 41, and permanent data such as lottery tables of base game and bonus game, payout tables (see FIG. 5 and FIG. 6), and the like. When the BIOS is executed by the main CPU 41, an initialization processing for certain peripheral devices is carried out and a fetch processing for fetching game program and the like is started through the gaming board 50.

The RAM 43 stores data and programs to be used when the main CPU 41 operates. The RAM 43 can store various programs to be read out through the gaming board 50, namely, the authentication program, the game program and the like, various information such as amount of credits a player currently holds, a variable N to be described later, and the like.

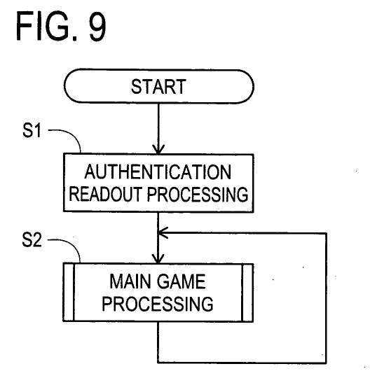

A communication interface 44 is connected to the mother board 40. The communication interface 44 is a communicating device for communicating with a server or the like installed in a game arcade through a communication line. The slot machine 1 communicates with a server or the like through the communication interface 44 to transmit bet information, a lottery result of a base-game lottery processing and the like which are dealt in a main game processing (see S2 in FIG. 9) to be described later.

A main body PCB 60 and a door PCB 80 both described later are separately connected to the mother board 40 with USB. Furthermore, a power supply unit 45 is connected to the mother board 40. When power is supplied to the mother board 40 from the power supply unit 45, the main CPU 41 in the mother board 40 is activated and at the same time, power is supplied to the gaming board 50 through PCI bus, whereby the CPU 51 is activated.

A game controller 100 is constituted by the mother board 40 and the gaming board 50.

On the other hand, devices for generating input signals to be inputted to the game controller 100 and devices of which operations are controlled by control signals outputted from the game controller 100 are connected to the main body PCB 60 and the door PCB 80. The game controller 100 executes the game program and the like stored in the RAM 43 in accordance with an input signal inputted to the game controller 100. Carrying out a certain processing operation, the game controller 100 stores a processing result in the RAM 43 and carries out control operation of various devices.

The lamp 35, the hopper 66, the coin detecting section 67, the graphic board 68, the speaker 28, the touch panel 11, the bill validator 22, the ticket printer 30, the card reader 31, the key switch 33S, and the data display 32 are connected to the main body PCB 60.

The touch panel 11 is provided on a front face of the lower-side image display panel 6. The touch panel 11 is capable of specifying a position in a coordinate touched by a player, and detecting a portion the player touched and which direction the touched portion has moved in accordance with the specified coordination position information.

The hopper 66 is provided inside of the cabinet 2 and pays out predetermined number of coins to the coin tray 24 through the coin payout opening 23 in accordance with a control signal outputted from the game controller 100. The coin detecting section 67 outputs an input signal to the game controller 100 when detecting payout of predetermined number of coins from the coin payout opening 23.

A graphic board 68 controls image display at the upper-side image display panel 7 and the lower-side image display panel 6 in accordance with a control signal outputted from the game controller 100. For example, amount of player's credits stored in the RAM 43 is displayed at the credit amount display section 8. Furthermore, amount of credits to be awarded as payouts is displayed at the payout amount display section 9.

The graphic board 68 is equipped with a VDP (Video Display Processor) for generating image data in accordance with control signals outputted from the game controller 100, a video RAM 69 for temporarily storing image data generated by the VDP, and the like. It is to be noted that image data used when generating image data with the VDP is included in the game program.

The graphic board 68 also controls motion image of the reels 5A, 5B, 5C, 5D, and 5E, namely, spinning and stopping of the reels 5A, 5B, 5C, 5D, and 5E, displayed in the lower-side image display panel 6 (see FIG. 1, FIG. 7, and FIG. 8) in accordance with control signals from the game controller 100.

Furthermore, the bill validator 22 discriminates forgery of a bill and a bar-code ticket 25 and accepts proper bill and bar-code ticket 25 into the cabinet 2. When accepting a proper bill, the bill validator 22 outputs an input signal to the game controller 100 based on value of the accepted bill. Furthermore, the bill validator 22 outputs an input signal to the game controller 100 based on the number of coins recorded in the proper bar-code ticket 25.

The ticket printer 30 prints a bar code in which data regarding amount of credits stored in the RAM 43 and the like are encoded in accordance with a control signals outputted from the game controller 100, and outputs the encoded data as bar-code ticket 25.

The card reader 31 reads data from a smart card to send it to the game controller 100 or writes data on a smart card in accordance with a control signal from the game controller 100. The key switch 33S is provided on the key pad 33 and outputs a certain input signal to the game controller 100 when the key pad 33 is operated by a player. The data display 32 displays data read out by the card reader 31 and data inputted by a player through the key pad 33 in accordance with a control signal outputted from the game controller 100.

A control panel 20, a reverter 21S, a coin counter 21C and a cold-cathode tube 81 are connected to the door PCB 80. The control panel 20 is equipped with a spin switch 13S directed to the spin button 13, a change switch 14S directed to the change button 14, a CASHOUT switch 15S directed to the CASHOUT button 15, a 1-BET switch 16S directed to the 1-BET button 16, and a MAX-BET switch 17S directed to the MAX-BET button 17. Each of the switches 13S through 17S outputs a signal to the game controller 100 when corresponding buttons are operated by a player.

The coin counter 21C is provided inside of the coin insertion slot 21 and discriminates forgery of a coin inserted in the coin insertion slot 21 by a player. Improper coins are ejected from the coin payout opening 23. The coin counter 21C outputs an input signal to the game controller 100 when detecting a proper coin.

The reverter 21S operates in accordance with a control signal outputted from the game controller 100 and divides and distributes coins discriminated as proper by the coin counter 21C to a cash box (not shown) or the hopper 66 both installed inside of the slot machine 1. The cold-cathode tube 81 works as back light arranged on rear-face sides of the lower-side image display panel 6 and the upper-side image display panel 7 and flashes in accordance with a control signal outputted from the game controller 100.

Next, by referring to FIG. 5 and FIG. 6, there will be described winning symbol combinations and payouts for them in case a base game is carried out with the slot machine 1 in which the reels 5A, 5B, 5C, 5D, and 5E are used. FIG. 5 is a first payout table showing winning symbol combinations and payouts for the respective winning symbol combinations in case a base game is carried out by using the reels 5A, 5B, 5C, 5D, and 5E.

It is to be noted that numerals indicated in the “PAYOUT” column are amount of payouts to be awarded per “1” bet. Therefore, in case the number of bets is “1”, payout value as shown in FIG. 5 is added to player's credits, and in case the number of bets is “2” or larger, a multiple of the number of bets on the payout value as shown in FIG. 5 is added to player's credits. Furthermore, in case plural winning symbol combinations are concurrently repositioned on plural activated pay lines L, payouts for the respective winning symbol combinations are totalized and awarded to a player.

For example, in case of winning a bonus game trigger, three, four, or five “RED7” symbols are repositioned on an activated pay line L in succession from the left-most display window 10A or from the right-most display window 10E, 20, 100, or 500 credits per 1-bet are awarded as payout and a bonus game occurs. In case two “RED7” symbols are repositioned on an activated pay line L in succession from the left-most display window 10A or from the right-most display window 10E, 4 credits per 1-bet are awarded as payout.

In case two, three, four, or five “BLUE7” symbols are repositioned on an activated pay line L in succession from the left-most display window 10A or from the right-most display window 10E, 3, 10, 25, or 250 credits per 1-bet are awarded as payout.

In case two, three, four, or five “BELL” symbols are repositioned on an activated pay line L in succession from the left-most display window 10A or from the right-most display window 10E, 3, 10, 25, or 250 credits per 1-bet are awarded as payout.

As to other winning symbol combinations listed therein, respective winning possibilities and amount of payouts per 1-bet have been set as shown in FIG. 5. However, in case a symbol combination repositioned on an activated pay line L does not coincide with any one of the winning symbol combinations shown in FIG. 5, it is a loss of a game and no credits are awarded (the cases as shown in FIG. 6 are excluded).

FIG. 6 is a second payout table showing winning symbol combinations and payouts for the respective winning symbol combinations in case of a base game is carried out by using the reels 5A, 5B, 5C, 5D, and 5E are used.

It is to be noted that numerals indicated in the “PAYOUT” column are amount of payouts to be awarded per “1” bet. Therefore, in case the number of bets is “1”, payout value as shown in FIG. 6 is added to player's credits, and in case the number of bets is “2” or larger, a multiple of the number of bets on the payout value as shown in FIG. 5 is added to player's credits.

According to the second payout table of FIG. 6, in case three, four, or five “ORANGE” symbols are repositioned in succession from the left-most display window 10A or from the right-most display window 10E regardless whether or not the scatter symbols are repositioned on an activated pay line L, 1, 4, or 50 credits per 1-bet are awarded as payout.

Next, there will be described main control program to be executed in the slot machine 1 of the present embodiment by referring to drawings. FIG. 9 is a flowchart of a main control program.

It is to be noted that, before the main control program is executed, the memory card 53 has been inserted in the card slot 53S of the gaming board 50 and the GAL 54 has been attached to the IC socket 54S.

When power is turned on at the power supply unit 45, the game controller 100 is activated and an authentication readout processing is carried out at S1. In the authentication readout processing, the mother board 40 and gaming board 50 both of which constitute the game controller 100 carry out their respective processing procedures separately and simultaneously.

That is, in the gaming board 50, the CPU 51 reads out the auxiliary authentication program stored in the boot ROM 52 and carries out auxiliary authentication in accordance with the auxiliary authentication program to verify and prove that no falsification of the program is found before fetching the program to the mother board 40.

On the other hand, in the mother board 40, the main CPU 41 executes the BIOS stored in the ROM 42, and gets compressed data included in the BIOS decompressed into the RAM 43, thereby to execute the BIOS decompressed into the RAM 43 and to carry out diagnosis and initialization of various peripheral devices.

After that, the game controller 100 reads out the authentication program stored in the ROM 55 and verifies and authenticates that the no falsification is found in the game program and the like stored in the memory card 53 inserted in the card slot 53S. After the authentication processing completes normally, the game controller 100 writes and stores the authenticated game program and the like in the RAM 43, and then, obtains payout rate setting data and country identification information.

After completion of the above procedures, the game controller 100 completes the authentication readout processing.

In S2, the game controller 100 sequentially reads out and executes the game program and the like authenticated at the authentication readout processing of S1 thereby to carry out a main game processing. By carrying out the main game processing, a game directed to the present embodiment is carried out with the slot machine 1. The main game processing is repeatedly carried out while power is supplied to the slot machine 1.

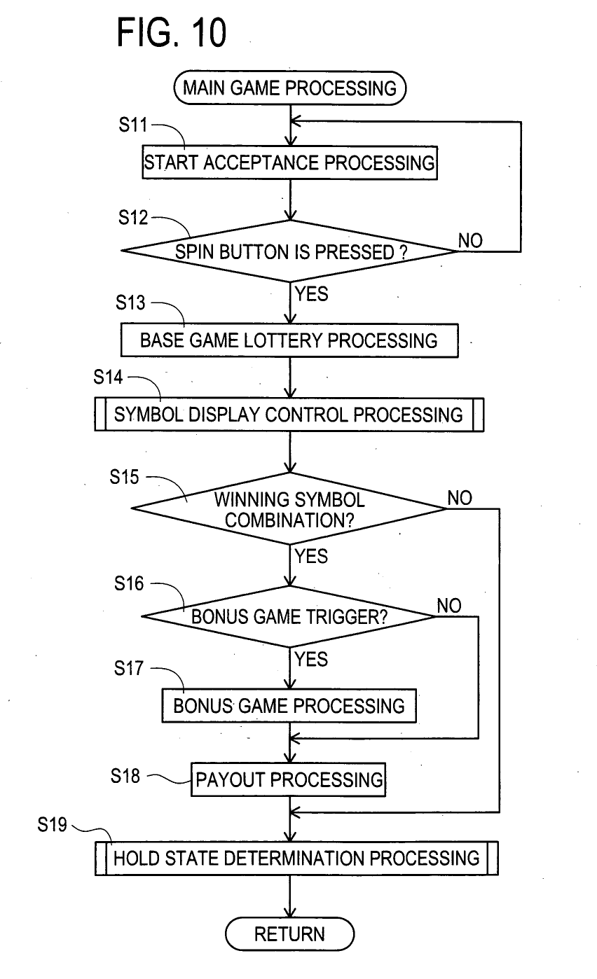

Next, there will be described a subroutine concerning the main game processing of S2 by referring to FIG. 10.

FIG. 10 shows the flowchart of the main game processing to be carried out in the slot machine 1 directed to the present embodiment. It is to be noted that programs indicated in the flowchart are stored in the ROM 42 or RAM 43 and executed by the game controller 100.

As shown in FIG. 10, the game controller 100 firstly carries out a start acceptance processing at S11 in which an inserted coin is accepted and the number of bets on the pay line L is set after predetermined initialization setting. At the start acceptance processing, insertion of a coin and bet operation with the 1-BET button 16 or the MAX-BET button 17 are done by a player.

In case of 1 bet, a pay line L1 is activated. In case of 2 bets, pay lines L1 and L2 are activated. In case of 3 bets, pay lines L1, L2, and L3 are activated. In case of 4 bets, pay lines L1, L2, L3, and L4 are activated. In case of 5 bets (maximum), pay lines L1, L2, L3, L4 and L5 are activated.

Next, the controller 100 judges whether or not the spin button 13 has been pressed at S12. For judging presence or absence of an input from the spin button 13, the game controller 100 detects whether or not to receive an input signal outputted from the spin switch 13S.

In case the spin button 13 is not pressed (S12: NO), the processing returns to the start acceptance processing (S11) again. Under this state, a player can change the number of bets or the like by operating bet buttons. In case the spin button 13 is pressed on (S12: YES), the number of bets equal to the number of to-be-activated pay lines among L1, L2, L3, L4, and L5 set by operating the 1-BET button 16 and the MAX-bet button 17 is subtracted from amount of credits a player currently holds, and stored in the RAM 43 as bet information.

After entering into S13, the game controller 100 carries out a base game processing in which the reels 5A, 5B, 5C, 5D, and 5E are used.

In S13, the game controller 100 carries out a base game lottery processing.

To be more specific, the game controller 100 executes a random number generating program included in the lottery program stored in the RAM 43, whereby a random number value is selected for each of the five reels 5A, 5B, 5C, 5D, and 5E from a numerical value range (0˜255). Next, the game controller 100 refers to symbol weight data (see FIG. 3) associated with the payout rate setting data and determines code numbers of the respective reels 5A, 5B, 5C, 5D, and 5E in accordance with selected five random number values. After the determined code numbers of the reels 5A, 5B, 5C, 5D, and 5E are stored in the RAM 43, the processing goes on to S14.

The determined code numbers of the respective reels 5A, 5B, 5C, 5D, and 5E correspond to code numbers of symbols to be repositioned on the pay line L1. Therefore, when the game controller 100 determines code numbers of the respective reels 5A, 5B, 5C, 5D, and 5E, a symbol combination in a target game is determined. For example, in case code numbers of the reels 5A, 5B, 5C, 5D, and 5E are determined as “21”, “21”, “21”, “21” and “21”, respectively, a symbol combination the game controller 100 has determined corresponds to five “RED7” symbols. By thus determining a symbol combination on the pay line L1, symbol combinations on the other pay lines L2, L3, L4 and L5 are concurrently determined. Thus, by determining code numbers directed to the respective reels 5A, 5B, 5C, 5D, and 5E, a symbol combination lottery (see FIG. 5 and FIG. 6) is carried out.

At S14, the game controller 100 carries out a symbol display control processing.

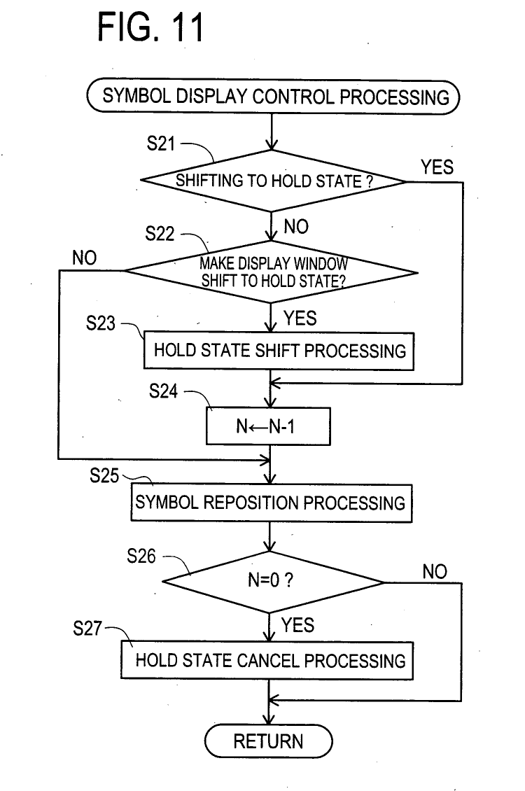

There will be described a subroutine concerning the symbol display control processing at S14 by referring to FIG. 11. FIG. 11 shows a flowchart of the symbol display control processing carried out in the slot machine 1 directed to the present embodiment. It is to be noted that programs executed in the flowchart of FIG. 11 are stored in the ROM 42 or the RAM 43 and executed by the game controller 100.

Firstly, as show in FIG. 11, the game controller 100 judges whether or not the some of the display windows 10A, 10B, 10C, 10D, and 10E are in the middle of shifting to hold state at S21. As previously described, “hold state” is a state in which a reel 5 does not spin and three symbols (three rows in a column) repositioned in a display window 10 in a preceding game are kept unchanged even when a current game (next game) begins.

This judgment is made in accordance with data stored in the RAM 43 at S23 to be described later. In case it is judged as in the middle of shifting to hold state (S21: YES), the processing goes on to S24 to be described later. In case it is judged as not in the middle of shifting to hold state (S21: NO), the processing goes on to S22.

At S22, the game controller 100 judges whether or not to make some of the display windows 10A, 10B, 10C, 10D, and 10E shift to hold state. This judgment is made in accordance with a lottery result stored in the RAM 43 at S33 to be described later. In case it is judged as not making the display windows 10 shift to hold state (S22: NO), the processing goes on to S25 to be described later. In case it is judged as making the display windows 10 shift to a hold state (S22: YES), the processing goes on to S23.

At S23, the game controller 100 carries out a hold state shift processing. At the hold state shift processing, data to notify that “a display window in which an “ORANGE” symbol was repositioned in a preceding game has been determined to be set in hold state” is stored in the RAM 43. To be more specific, as shown at the upper stage of FIG. 1, in case an “ORANGE” symbol is repositioned in each of the display windows 10A, 10B, and 10C in a preceding game and the processing goes on to S23 at a current game (next game), the data to notify that “the display windows 10A, 10B, and 10C will be set in hold state” is stored in the RAM 43.

At S24, the game controller 100 subtracts “1” from a variable N set in the RAM 43 and the processing goes on to S25.

The game controller 100 carries out a symbol reposition processing at S25. The symbol reposition processing is to control to stop spinning of all of the reels 5A, 5B, 5C, 5D, and 5E so as to reposition a symbol combination determined at the base game lottery processing (S13) on the pay line L1 in case there is no display window 10 to be set in hold state in a next game. This processing is carried out between the game controller 100 and the graphic board 68.

To be more specific, the game controller 100 sends the graphic board 68 a start signal to start spinning of the reels. Upon receiving the start signal, the graphic board 68 carries out a spinning-reel-image display processing. That is, the graphic board 68 carries out display control and starts displaying a motion image of spinning reels 5A, 5B, 5C, 5D, and 5E in the lower-side image display panel 6.

After sending the start signal, the game controller 100 determines effects to be carried out in a game (e.g., image to be displayed in the upper-side image display panel 7 and sound to be outputted from the speaker 28) and starts carrying out effects in accordance with the determined amusing manner.

When comes a predetermined timing to stop spinning of the reels 5A, 5B, 5C, 5D, and 5E, the game controller 100 sends code numbers of the respective reels to the graphic board 68. The graphic board 68 carries out a stopped-reel-image display processing in accordance with the code numbers assigned to the respective reels. Thereby, symbols associated with a lottery result at S13 are repositioned on the pay line L1 which runs across the display windows 10A, 10B, 10C, 10D, and 10E in the lower-side image display panel 6.

In case there is a display window 10 to be set in hold state, corresponding reel 5 is excluded from control and spinning of the reel 5 is not carried out in a next game. In this regard, presence/absence of a display window 10 to be set in hold state is determined in accordance with data stored in the RAM 43 at S23. Therefore, for example, in case an “ORANGE” symbol was repositioned in each of the display windows 10A, 10B, and 10C in a preceding game as shown at the upper stage of FIG. 1 and the processing has reached S23 in the current game (next game), spinning of the reels 5A, 5B, and 5C corresponding to the display windows 10A, 10B, and 10C, respectively, is not carried out and repositioning of three symbols since the preceding game is kept unchanged in each of the display windows 10A, 10B, and 10C as shown at the middle stage of FIG. 1. At this moment, a sign of “HOLD” is indicated above each of the display windows 10A, 10B, and 10C to mean that repositioning of three symbols in a “HOLD”-sign-indicated display window 10 is kept unchanged under hold state, as shown at the middle and lower stages of FIG. 1. On the other hand, there is carried out spinning and stopping of the reels 5D and 5E corresponding to the display windows 10D and 10E, respectively, as shown at the middle and lower stages of FIG. 1. Three symbols (three rows in a column) are thus repositioned in each of the display windows 10A, 10B, 10C, 10D, and 10E in the current game.

Next, the game controller 100 judges whether or not a variable N stored in the RAM 43 is “0” at S26. In case the variable N is judged as not “0” (S26: NO), the processing returns to the main game processing of FIG. 10. In case the variable N is judged as “0” (S26: YES), the processing goes on to S27.

The game controller 100 carries out a hold state cancel processing at S27. The hold state cancel processing is to delete the data stored in the RAM 43 at S23. Thereby, a display window 10 to be set in hold state is no longer an object of hold state. After that, the processing returns to the main game processing of FIG. 10.

Returning to the main game processing of FIG. 10, the game controller 100 judges whether or not a symbol combination coincides with a winning symbol combination at S15. This judgment is made in accordance with code numbers recorded in the RAM 43 at S13 and the first and second payout tables (see FIG. 5 and FIG. 6). In case it is judged as winning symbol combination (S15: YES) the processing goes on to S16. In case it is judged as not winning symbol combination (S15: NO), the processing goes on to S19 to be described later.

At S16, the game controller 100 judges whether or not a bonus game trigger is won in a base game. To be more specific, provided that the first payout table of FIG. 5 is used, in case a symbol combination of three, four, or five “RED7” symbols are repositioned on an activated pay line L, it is judged as winning a bonus game trigger

In case of a bonus game trigger (S16: YES), the game controller 100 carries out an optional type bonus game processing at S17. Details of the bonus game processing will be omitted here. After that, including “after the judgment of not a bonus game trigger” (S16: NO), the game controller 100 carries out a payout processing (S18). At the payout processing, total payouts won in a base game and a bonus game are awarded to a player.

In case it is in the middle of shifting to hold state in a base game, a payout already awarded during this hold state will not be awarded again. To be more specific, in case there has already been awarded a payout for repositioning of three “ORANGE” symbols in the display windows 10A, 10B, and 10C as shown at the upper stage of FIG. 1 and an “ORANGE” symbol is newly repositioned in the display window 10D in addition to the display windows 10A, 10B, and 10C set in hold state in the next game as shown at the lower left stage of FIG. 1, there will be awarded a payout for the four “ORANGE” symbols repositioned in the display windows 10A, 10B, 10C, and 10D but will not be awarded for the preceding repositioning of three “ORANGE” symbols in the display windows 10A, 10B, and 10C. It is to be noted that data concerning types of payouts which have been awarded and the like are stored in the RAM 43.

At the payout processing, payout can be made with coins equivalent to amount of credits (lcredit per 1 coin) by pressing the CASHOUT button 15, or made with a bar-code ticket 25.

After the payout processing, the processing goes on to S19.

At S19, the game controller 100 carries out a hold state determination processing.

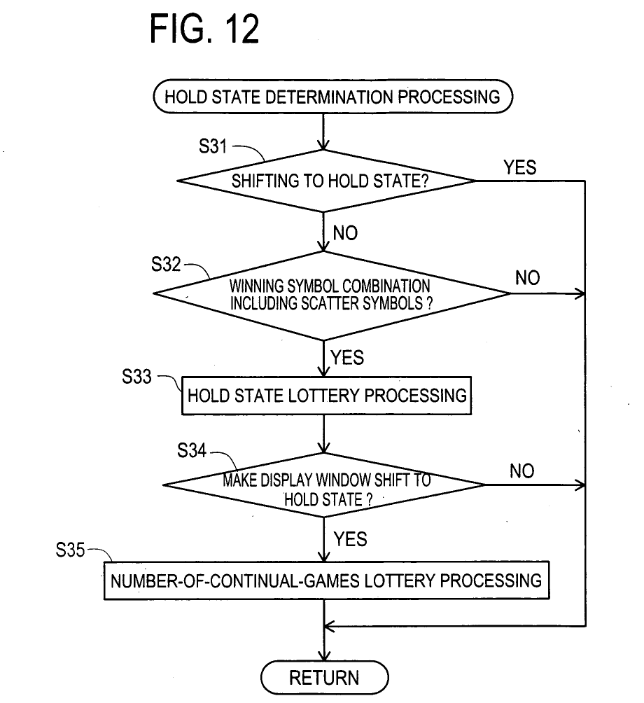

There will be described a subroutine of the hold state determination processing at S19 by referring to FIG. 12. FIG. 12 shows a flowchart of a hold state determination program of the slot machine 1 directed to the present embodiment. It is to be noted that programs in the flowchart of FIG. 12 are stored in the ROM 42 or the RAM 43 and executed by the game controller 100.

As shown in FIG. 12, the game controller 100 firstly judges whether or not some of the display windows 10A, 10B, 10C, 10D, and 10E are in the middle of shifting to hold state at S31. This judgment is made in a manner similar to S21. In case it is judged as in the middle of shifting to hold state (S31: YES), the processing returns to the main game processing of FIG. 10. In case it is judged as not in the middle of shifting to hold state (S31: NO), the processing goes on to S32.

At S32, the game controller 100 judges whether or not there is a payout for repositioning of three or more “ORANGE” symbols in succession in some of the five display windows 10A, 10B, 10C, 10D, and 10E in a current game. That is, it is judged whether or not there is a “scatter-and-any combination payout” in the current games. This judgment is made in accordance with the data stored in the RAM 43 at S18. In case it is judged as there is not a payout for repositioning of “ORANGE” symbols (S32: NO), the processing returns to the main game processing of FIG. 10. In case it is judged as there is a payout for repositioning of “ORANGE” symbols (S32: YES), the processing goes on to S33.

At S33, the game controller 100 carries out hold state lottery processing. To be more specific, a random number generating program included in a lottery program stored in the RAM 43 is executed, whereby a random number is selected from a numerical value range (0˜255). After that, it is determined whether or not to make a display window 10 shift to hold state in a next game in accordance with a selected random number and the determination (a lottery result) is stored in the RAM 43.

At S34, the game controller 100 determines whether or not to make a display window 10 shift to hold state in a next game. This determination is made in accordance with the decision (the lottery result) stored in the RAM 43 at S33. In case it is determined not to make the display window 10 shift to hold state in the next game (S34: NO), the processing returns to the main game processing of FIG. 10. In case it is determined to make the display window 10 shift to hold state in the next game (S34: YES), the processing goes on to S35.

At S35, the game controller 100 carries out a number-of-continual-games lottery processing. To be more specific, the random number generating program included in the lottery program stored in the RAM 43 is executed, whereby a random number is selected from a numerical value range (0˜255). The number of continual games to keep hold state is determined in accordance with the selected random number and the determined number of continual games is substituted for the variable N at the RAM 43.

After that, the processing returns to the main game processing of FIG. 10

It is to be noted that the present invention is not restricted to the above-described embodiment but, not to mention, it can be variously improved and changed within the scope not departing from the subject matter thereof.

For example, in case an “ORANGE” symbol was repositioned in a display window 10 in a preceding game, the display window 10 including reposition of an “ORANGE” symbol may surely be set in hold state in next predetermined number of continual games or may surely be set in hold state in a next single game.

In case it is in the middle of shifting to hold state in a base game, a payout same as the one awarded in a preceding game may be paid out again in a next game.

Furthermore, the present invention is also applicable to a slot machine which employs mechanical reels instead of video reels. An outline construction and a circuit structure of a mechanical reel type slot machine are similar to those of the slot machine 1 and so are the flowcharts concerning operational control of it. Therefore, numerals same as those of the slot machine 1 are assigned to similar structural portions and procedural steps of the mechanical reel type slot machine and description of them will be omitted. Only portions different from the slot machine 1 will be described hereafter.

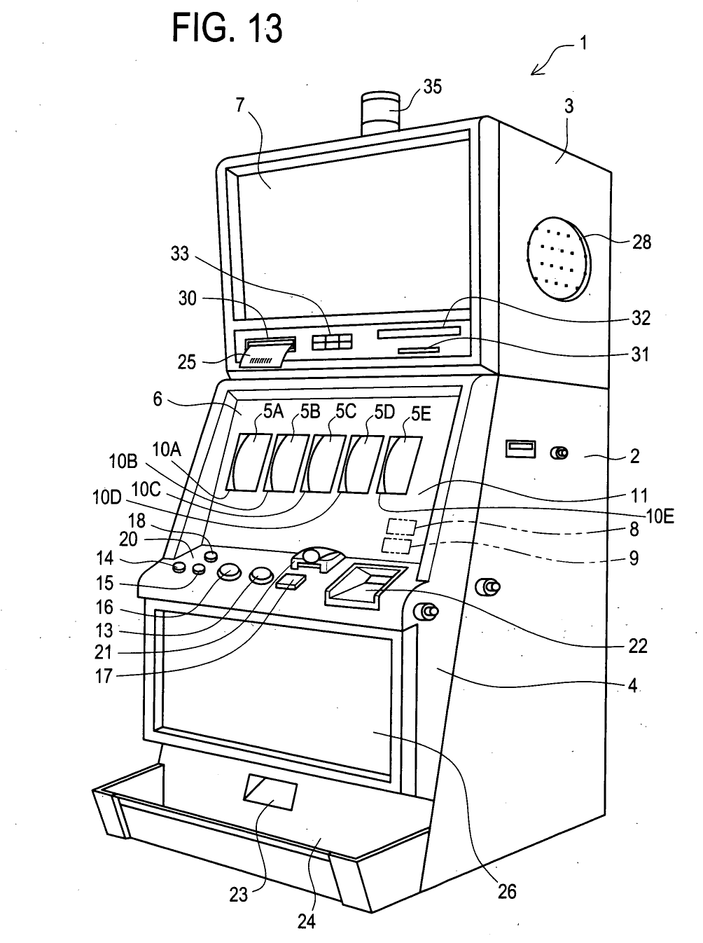

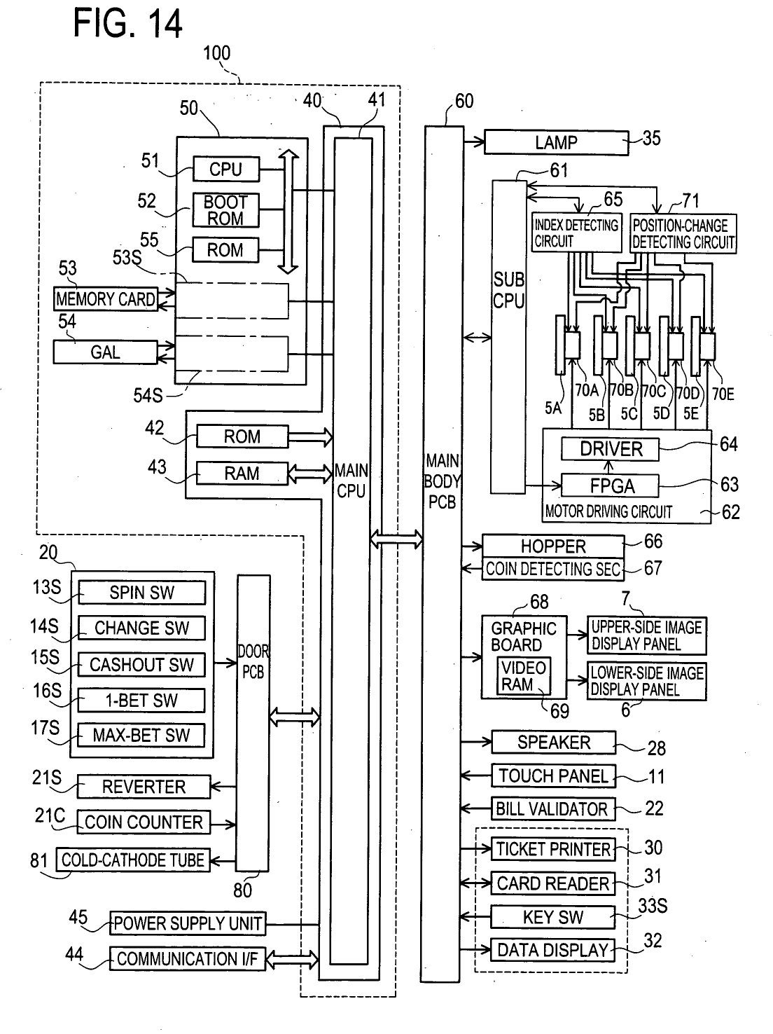

FIG. 13 is a perspective view showing an outline construction of a mechanical reel type slot machine directed to other embodiment. FIG. 14 is an exemplary block diagram showing a control system of the reel type slot machine.

As shown in FIG. 13 and FIG. 14, a part of a symbol column depicted on reels bands of respective reels 5A, 5B, 5C, 5D, and 5E is displayed through corresponding display widows 10A, 10B, 10C, 10D, and 10E all of which are provided on a lower-side image display panel 6. Three symbols (three rows in a column) are repositioned in each of the display windows 10A, 10B, 10C, 10D, and 10E.

Those reels 5A, 5B, 5C, 5D, and 5E are mechanical type reels and controlled by a sub CPU 61 in a symbol reposition processing at S25. That is, an FPGA (Field Programmable Gate Array) 63 and a motor driving circuit 62 equipped with a driver 64 are connected to the sub CPU 61 which is further connected to a main body PCB 60. The FPGA 63 is a programmable electric circuit such as LSI and works as control circuit for controlling stepping motors 70A, 70B, 70C, 70D, and 70E. The driver 64 works as amplifying circuit for amplifying pulses to be inputted to the stepping motors 70A, 70B, 70C, 70D, and 70E. The stepping motors 70A, 70B, 70C, 70D, and 70E for spinning the reels 5A, 5B, 5C, 5D, and 5E, respectively, are connected to the motor driving circuit 62. The stepping motors 70A, 70B, 70C, 70D, and 70E are 1-2 phase excitation type stepping motors.

An index detecting circuit 65 and a position-change detecting circuit 71 are connected to the sub CPU 61. The index detecting circuit 65 is to detect positions of the reels 5A, 5B, 5C, 5D, and 5E in spinning (e.g., reference position) and capable of detecting step-out of the reels 5A, 5B, 5C, 5D, and 5E.

The position-change detecting circuit 71 detects stop-position change of the reels 5A, 5B, 5C, 5D, and 5E after they stop spinning. For example, the position-change detecting circuit 71 detects stop-position changes of the reels 5A, 5B, 5C, 5D, and 5E in such a case that stop positions of them are forcibly changed to positions to coincide with a winning symbol combination by a player although it is not the winning symbol combination in fact.

Therefore, a game controller 100 controls spinning and stopping of the reels 5A, 5B, 5C, 5D, and 5E in the symbol reposition processing at S25 by giving an instruction to the sub CPU 61 which control those structural elements.

It is to be noted that the lower-side image display panel 6 is structured with a well-known crystal liquid panel. During a base game, the game controller 100 makes the display windows 10A, 10B, 10C, 10D, and 10E transparent and makes symbols depicted on the reels 5A, 5B, 5C, 5D, and 5E visible by giving an instruction to a graphic board 68. During a bonus game, the game controller 100 makes the display windows 10A, 10B, 10C, 10D, and 10E in the lower-side image display panel 6 non-transparent and displays a predetermined bonus game image by giving an instruction to a graphic board 68.

What is claimed is:

1. A slot machine comprising:
a display for displaying plural symbols positioned;
at least one scatter symbol to which a payout is awarded depending on number of scatter symbols displayed in the display; and
a game controller programmed to operate with the display
(a) to cause the display to newly reposition and display plural symbols every game, and
(b) set all of the at least one scatter symbol displayed in a preceding game in hold state by excluding all of the at least one scatter symbol from repositioning when the display newly repositions and displays plural symbols in a next game.

2. A slot machine according to claim 1, wherein, in case at least one scatter symbol has been displayed in a preceding game, the game controller is programmed to award a payout depending on number of scatter symbols displayed in the preceding game firstly and then determine whether or not to set all of the at least one scatter symbol displayed in the preceding game in hold state by excluding all of the at least one scatter symbol from repositioning when the display newly repositions and displays plural symbols in a next game.

3. A slot machine according to claim 1, wherein, in case at least one scatter symbol has been displayed in a preceding game, the game controller is programmed to determine number of continual games to keep setting all of the at least one scatter symbol displayed in the preceding game in hold state by excluding all of the at least one scatter symbol from repositioning when the display newly repositions and displays plural symbols in a next game.

4. A slot machine according to claim 1, wherein, in case the game controller has operated to set all of the at least one scatter symbol displayed in a preceding game in hold state by excluding all of the at least one scatter symbol from repositioning when the display newly repositions and displays plural symbols and the display newly displays a scatter symbol aside from all of the at least one scatter symbol set in hold state in a next game, the game controller is programmed to award a payout depending on number of total scatter symbols including the scatter symbol newly displayed.

5. A slot machine comprising:
a display for displaying plural symbols positioned;
at least one scatter symbol to which a payout is awarded depending on number of scatter symbols displayed in the display; and
a game controller programmed to operate with the display
(a) to cause the display to newly reposition and display plural symbols every game, and
(b) in case at least one scatter symbol has been displayed in a preceding game,
(1) to award a payout depending on number of scatter symbols displayed in the preceding game firstly and then, to determine whether or not to set all of the at least one scatter symbol in hold state by excluding all of the at least one scatter symbol from repositioning when the display newly repositions and displays plural symbols in a next game,
(2) to determine number of continual games to keep setting all of the at least one scatter symbol displayed in the preceding game in hold state by excluding all of the at least one scatter symbol from repositioning when the display newly repositions and displays plural symbols on condition that a determination at (1) is to set all of the at least one scatter symbol in hold state in the next game, and
(3) to cause the display to newly reposition and display plural symbols in accordance with determinations at (1) and (2).

6. A slot machine comprising:
a display for displaying plural symbols positioned;
at least one scatter symbol to which a payout is awarded depending on number of scatter symbols displayed in the display; and
a game controller programmed to operate with the display
(a) to cause the display to newly reposition and display plural symbols every game, and
(b) in case at least one scatter symbol has been displayed in a preceding game,
(1) to award a payout depending on number of scatter symbols displayed in the preceding game firstly and then, to determine whether or not to set all of the at least one scatter symbol in hold state by excluding all of the at least one scatter symbol from repositioning when the display newly repositions and displays plural symbols in a next game,
(2) to cause the display to newly reposition and display plural symbols on condition that a determination at (1) is to set all of the at least one scatter symbol in hold state in the next game, and
(3) in case the display newly displays a scatter symbol in the next game, to award a payout depending on number of total scatter symbols including the scatter symbol newly displayed.

7. A slot machine comprising:
a display for displaying plural symbols positioned;
at least one scatter symbol to which a payout is awarded depending on number of scatter symbols displayed in the display; and
a game controller programmed to operate with the display
(a) to cause the display to newly reposition and display plural symbols every game, and
(b) in case at least one scatter symbol has been displayed in a preceding game,
(1) to award a payout depending on number of scatter symbols displayed in the preceding game firstly and then, to determine whether or not to set all of the at least one scatter symbol in hold state by excluding all of the at least one scatter symbol from repositioning when the display newly repositions and displays plural symbols in a next game,
(2) to determine number of continual games to keep setting all of the at least one scatter symbol displayed in the preceding game in hold state by excluding all of the at least one scatter symbol from repositioning when the display newly repositions and displays plural symbols on condition that a determination at (1) is to set all of the at least one scatter symbol in hold state in the next game,
(3) to cause the display to newly reposition and display plural symbols in accordance with determinations at (1) and (2), and
(4) in case the display newly displays a scatter symbol in the next game, to award a payout depending on number of total scatter symbols including the scatter symbol newly displayed.

8. A method of playing a slot machine in which game controller repeats a game by using a display which newly repositions and displays plural symbols and at least one scatter symbol to which a payout is awarded depending on number of scatter symbols displayed in the display, the playing method comprising steps of:
(a) causing the display to newly reposition and display plural symbols every game with the game controller; and
(b) setting all of the at least one scatter symbol displayed in a preceding game in hold state by excluding all of the at least one scatter symbol from repositioning with the game controller when the display newly repositions and displays plural symbols in a next game.

9. A method of playing a slot machine according to claim 8, wherein, in case at least one scatter symbol has been displayed in a preceding game, the step (b) further comprises a step of awarding a payout depending on number of scatter symbols displayed in the preceding game firstly and then determining whether or not to set all of the at least one scatter symbol displayed in the preceding game in hold state by excluding all of the at least one scatter symbol from repositioning with the game controller when the display newly repositions and displays plural symbols in a next game.

10. A method of playing a slot machine according to claim 8, wherein, in case at least one scatter symbol has been displayed in a preceding game, the step (b) further comprises a step of determining number of continual games to keep setting all of the at least one scatter symbol displayed in the preceding game in hold state by excluding all of the at least one scatter symbol from repositioning with the game controller when the display newly repositions and displays plural symbols.

11. A method of playing a slot machine according to claim 8, wherein, in case the step (b) is carried out by the game controller and the display newly displays a scatter symbol aside from all of the at least one scatter symbol set in hold state in a next game, the step (b) further comprises a step of awarding a payout depending on number of total scatter symbols including the scatter symbol newly displayed with the game controller.

12. A method of playing a slot machine in which game controller repeats a game by using a display which newly repositions and displays plural symbols and at least one scatter symbol to which a payout is awarded depending on number of scatter symbols displayed in the display, the playing method comprising steps of:
(a) causing the display to newly reposition and display plural symbols every game with the game controller;
(b) in case at least one scatter symbol has been displayed in a preceding game, awarding a payout depending on number of scatter symbols displayed in the preceding game firstly and then, determining whether or not to set all of the at least one scatter symbol in hold state by excluding all of the at least one scatter symbol from repositioning with the game controller when the display newly repositions and displays plural symbols in a next game;
(c) determining number of continual games to keep setting all of the at least one scatter symbol displayed in the preceding game in hold state by excluding all of the at least one scatter symbol from repositioning with the game controller when the display newly repositions and displays plural symbols on condition that a determination at the step (b) is to set all of the at least one scatter symbol in hold state in the next game; and
(d) causing the display to newly reposition and display plural symbols in accordance with determinations at the steps (1) and (2) with the game controller.

13. A method of playing a slot machine in which game controller repeats a game by using a display which newly repositions and displays plural symbols and at least one scatter symbol to which a payout is awarded depending on number of scatter symbols displayed in the display, the playing method comprising steps of:
(a) causing the display to newly reposition and display plural symbols every game with the game controller;
(b) in case at least one scatter symbol has been displayed in a preceding game, awarding a payout depending on number of scatter symbols displayed in the preceding game firstly and then, determining whether or not to set all of the at least one scatter symbol in hold state by excluding all of the at least one scatter symbol from repositioning with the game controller when the display newly repositions and displays plural symbols in a next game;
(c) causing the display to newly reposition and display plural symbols with the game controller on condition that a determination at the step (b) is to set all of the at least one scatter symbol in hold state in the next game; and
(d) in case the display newly displays a scatter symbol in the next game at the step (c), awarding a payout depending on number of total scatter symbols including the scatter symbol newly displayed with the game controller.

14. A method of playing a slot machine in which game controller repeats a game by using a display which newly repositions and displays plural symbols and at least one scatter symbol to which a payout is awarded depending on number of scatter symbols displayed in the display, the playing method comprising steps of:
(a) causing the display to newly reposition and display plural symbols every game with the game controller;
(b) in case at least one scatter symbol has been displayed in a preceding game, awarding a payout depending on number of scatter symbols displayed in the preceding game firstly and then, determining whether or not to set all of the at least one scatter symbol in hold state by excluding all of the at least one scatter symbol from repositioning with the game controller when the display newly repositions and displays plural symbols in a next game;
(c) determining number of continual games to keep setting all of the at least one scatter symbol displayed in the preceding game in hold state by excluding all of the at least one scatter symbol from repositioning with the game controller when the display newly repositions and displays plural symbols on condition that a determination at the step (b) is to set all of the at least one scatter symbol in hold state in the next game;
(d) causing the display to newly reposition and display plural symbols in accordance with determinations at the steps (b) and (c) with the game controller; and
(e) in case the display newly displays a scatter symbol in the next game, awarding a payout depending on number of total scatter symbols including the scatter symbol newly displayed with the game controller.
